(19) United States
(12) Patent Application Publication
(10) Pub. No.: US 2019/0286189 A1
(43) Pub. Date: Sep. 19, 2019

(54) WEARABLE ELECTRONIC DEVICE HAVING A REMOVABLE CONTROL MODULE

(71) Applicant: North Inc., Kitchener (CA)

(72) Inventors: Jason T. Griffin, Kitchener (CA); Steven Henry Fyke, Waterloo (CA)

(21) Appl. No.: 16/351,352

(22) Filed: Mar. 12, 2019

Related U.S. Application Data
(60) Provisional application No. 62/642,490, filed on Mar. 13, 2018.

(51) Int. Cl. G06F 1/16; G06F 3/01; A44C 9/00

(52) U.S. Cl. CPC G06F 1/163; G06F 3/014; A44C 9/0053; G06F 1/1635; G06F 1/1698

(57) ABSTRACT

Wearable electronic devices advantageously have removable control modules. The wearable electronic devices include a body defining an aperture there through and a control module removably coupled to the body. The aperture is sized and shaped to receive a finger of a user. The removable control module includes a computer processor, an input device to receive input from another finger of the user, a transmitter coupled to the computer processor and operable to send electronic transmissions to an external electronic device, the electronic transmissions corresponding to the inputs received from the user. The removable control module may further include a power system, electrically coupled to provide electrical power to the computer processor, the input device and the transmitter.

### TECHNICAL FIELD

The present systems, devices, and methods generally relate to wearable electronic devices and particularly relate to wearable electronic devices having removable control modules.

### BACKGROUND

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be “wireless” (i.e., designed to operate without any wire-connections to other, non-portable electronic systems); however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

Because they are worn on the body of the user, visible to others, and generally present for long periods of time, form factor (i.e., size, geometry, and appearance) is a major design consideration in wearable electronic devices.

### BRIEF SUMMARY

The various embodiments described herein generally relate to wearable electronic devices with removable control modules.

In some embodiments, the wearable electronic devices can include a body defining an aperture there through and a control module removably coupled to the body. The aperture is sized and shaped to receive a finger of a user. The wearable electronic device includes a computer processor, an input device to receive input from another finger of the user, a transmitter coupled to the computer processor and operable to send electronic transmissions to an external electronic device, the electronic transmissions corresponding to the inputs received from the user. The removable control module may additionally include a power system or a holder to hold a power system. The power system provides electrical power to the computer processor, the input device and the transmitter.

A wearable electronic device, wearable on a finger of a user, may be summarized as including: a body defining an aperture therethrough, the aperture sized and shaped to receive the finger of the user; and a control module removably coupleable to the body, the control module including: a computer processor; an input device to receive an input from another finger of the user; a transmitter communicatively coupled to the computer processor and operable to send electronic transmissions to an external electronic device, the electronic transmissions corresponding to the input received from the user. The control module may further include: a power system electrically coupled to provide electrical power to the computer processor, the input device, and the transmitter.

The control module may further include a first mounting surface having at least one fastener aperture defined therein to receive a fastener, wherein the first mounting surface rests against a first edge of the body when the control module is mounted to the body. The control module may further include a second mounting surface having at least one fastener aperture defined therein to receive a fastener, wherein the second mounting surface is removable and rests against a second edge of the body when the control module is mounted to the body.

The body may have an annular shape to be worn on the finger of the user.

The body may further include a planar mounting surface that extends from an outer surface of the body. The planar mounting surface may define at least one fastener aperture sized and shaped to receive a fastener for mounting the control module to the body. The at least one fastener aperture may extend through the planar mounting surface between a first side of the body and a second side of the body. The mounting surface may extend between the body and a first end of the body. The control module may further include at least one extension that is releaseably insertable into the at least one fastener aperture to releaseably mount the control module to the body.

The body may define an opening extending between an inner surface of the body and an outer surface of the body, the opening shaped and sized to receive at least a portion of the control module to mount the control module to the body. The body may include a side mounting surface and an end mounting surface that together define the opening, wherein the control module rests against the side mounting surface and the end mounting surface when mounted to the body. The side mounting surface may include a recess via which the control module is mountable to the body. The recess may extend between the inner surface of the body and the outer surface of the body. The control module may include an extension sized and shaped to slidingly engage the recess to mount the control module to the body.

The body may include two side mounting surfaces and two end mounting surfaces that collectively define the opening, wherein the control module rests against the side mounting surfaces and the end mounting surfaces when mounted to the body. Each side mounting surface may include a respective recess via which the control module is mountable to the body. Each recess may extend between the inner surface of the body and the outer surface of the body. The control module may include two extensions, each extension sized and shaped to slidingly engage a respective one of the recesses to releaseably mount the control module to the body.

The body may include an upper projection and a lower projection spaced apart from each other to define an opening, the opening sized and shaped to receive the control module to releaseably mount the control module to the body. Each of the upper and the lower projections may have a planar shape and may extend in a direction away from the finger of the user when the body is placed on the finger of the user. Each of the upper and the lower projections may include an extension via which the control module is releaseably mountable to the body. The control module may include two recesses sized and shaped to slidingly receive one of the extensions of the body when the control module is positioned between the upper and the lower projections. The extensions may have a rounded shape and may be axially aligned, and the control module may be releaseably mounted to rotate about an axis defined by the projections.

The body may include an upper projection, a lower projection spaced apart from the upper projection, and a post extending between the upper projection and the lower projection, the upper and the lower projections defining an opening, the opening sized and shaped to receive the control module to mount the control module to the body. Each of the upper and the lower projections may have a planar shape and may extend in a direction away from the finger of the user when the body is placed on the finger of the user. The control module may include a recess sized and shaped to slidingly receive the post when the control module is positioned between the upper and lower projections. The post may have a rounded shape, and the control module may be rotatable about an axis defined by the post.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a perspective view of a wearable electronic device having a removable control module, according to at least one implementation;

FIGS. 2A to 2C are side, front and top views, respectively, of the wearable electronic device of FIG. 1;

FIGS. 3A to 3D are side, partially-exploded front, partially-exploded perspective, and partially-exploded top views, respectively, of the wearable electronic device of FIG. 1;

FIG. 4 is a perspective view of a wearable electronic device having a removable control module, according to at least another implementation;

FIGS. 5A to 5E are right side, front, left side, top and left side perspective views, respectively, of the wearable electronic device of FIG. 4;

FIGS. 6A to 6F are right side, partially-exploded front, left side, partially-exploded right side perspective, partially-exploded top, and partially-exploded left side perspective views, respectively, of the wearable electronic device of FIG. 4;

FIG. 7 is a perspective view of a wearable electronic device having a removable control module, according to yet at least another implementation;

FIGS. 8A to 8C are front, left side and top views, respectively, of the wearable electronic device of FIG. 7;

FIGS. 9A to 9D are front, partially-exploded left side, partially-exploded top, and partially-exploded left side perspective views of the wearable electronic device of FIG. 7;

FIG. 10 is a perspective view of a wearable electronic device having a removable control module, according to at least a further implementation;

FIGS. 11A to 11C are front, left side and top views, respectively, of the wearable electronic device of FIG. 10;

FIGS. 12A to 12D are front, partially-exploded left side, partially-exploded top, and partially-exploded left side perspective views, respectively, of the wearable electronic device of FIG. 10;

FIG. 13 is a perspective view of a wearable electronic device having a removable control module, according to still at least a further implementation;

FIGS. 14A to 14C are front, left side and top views, respectively, of the wearable electronic device of FIG. 13;

FIGS. 15A to 15D are front, partially-exploded left side, partially-exploded top, and partially-exploded left side perspective views of the wearable electronic device of FIG. 1;

FIG. 16 is a block diagram illustrating a wearable electronic device, according to at least one implementation; and

FIG. 17 is a block diagram illustrating a wearable electronic device communicating with an external electronic device, according to at least one implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

A user may have more than one wearable electronic device and it can be desirable to have wearable electronic devices of different sizes for comfort. When such wearable electronic devices are used and communicate with another electronic device, it can be desirable to have the communication hardware of the wearable electronic device be transferable between wearable electronic devices.

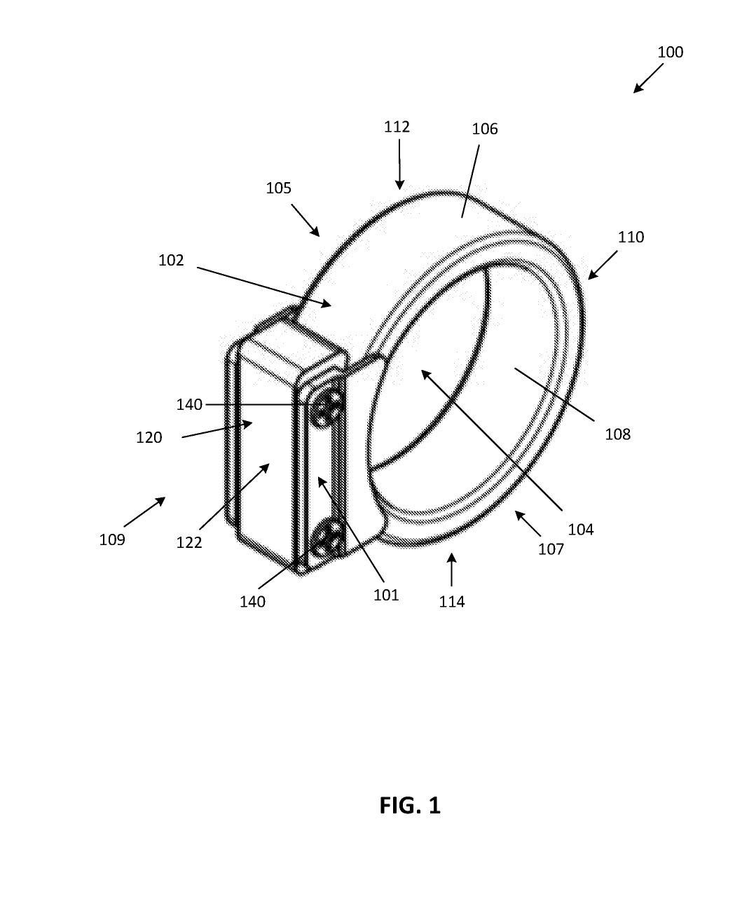

Referring to FIG. 1, illustrated therein is a wearable electronic device 100 having a removable control module 101 that houses one or more electronic components (such as but not limited to a processor, memory, sensors, a charging member such as an inductive coil, electrical contacts, and/or recharging circuitry, etc., as further described below), according to at least one implementation. The body may, for example, provide environmental protection of the electronic components from exterior conditions, as well as provide an electrically insulative barrier between the electronic components and the user.

Wearable electronic device 100 has a body 102 that defines an aperture 104 shaped and dimensioned to receive a first finger of a user. Body 102 has a first side 105, a second side 107 opposed to the first side 105, a first end 109 and a second end 110 opposed to the first end 109, and a top portion 112 and a bottom 114 portion opposed to the top portion 112. Body 102 may generally have an annular shape and includes an outer surface 106 and an inner surface 108.

The inner surface 108 is sized and/or shaped to securely, removably, receive the first finger of the user, for example the index finger. The inner surface 108 thereby rests against a portion of the first finger when the device 100 is worn by the user. Wearable electronic device 100 may be available in a variety of sizes for accommodating various finger sizes and/or various types of fingers.

In some implementations, the body 102 is made from a rigid or semi-rigid material such as a metal or a plastic. For instance, the body 102 may be made of gold, silver, platinum, or any other suitable metal.

In the implementation shown in FIGS. 1 to 3, outer surface 106 has a control module 101 removably mounted thereon. Control module 101 includes one or more user input devices 120 for the wearable electronic device 100 to receive inputs from a user. The input device 120 can assume a wide variety of forms appropriate for actuation by a second finger of the user (e.g., by a finger other than the finger upon which the wearable electronic device is worn). As used herein and in the claims, finger refers to any digit of a hand, including the thumb.

The input device 120 can be mechanical, electro-mechanical, and/or sensor (e.g., a membrane sensor)-based, and in more general terms provides an actuation surface 122 for receiving a user-applied actuation force or action.

A user can actuate the input device 120 by engaging and/or applying a force to the actuation surface 122. The input device 120 may be configured to be positively actuated only upon the contact of a certain percentage of the actuation surface 122 or certain minimum pressure on a pressure sensor-type switch to avoid unintended activation.

The input device 120 may be any shape or size while still providing ample control for a user with a finger other than the finger upon which the device is worn. According to some embodiments, the input device 120 can be sized and shaped to have the smallest size while still providing ample control for a user with a second finger (e.g., thumb of the same hand) other than the first finger (e.g., index finger of the hand) upon which the device is worn.

An input can be provided to the wearable electronic device 100 by the user engaging input device 120. For instance, a user can engage the input device 120 when a finger of the user makes physical contact with input device 120 and actuates the input device 120. The physical actuation (e.g., manipulation) of the actuating surface 122 of the input device 120 is received and recognized by a processor (described below) of the device. In some embodiments, the pressure of the engagement and/or manipulation of the actuation surface 122 is translated by the processor into a computer-readable form. The processor then compares the engagement and or manipulation of the actuation surface by the user to a plurality of stored manipulations based on the input. The input may be, for example, a tap, or a double-tap (e.g., two successive touches or contacts within a given period of time), or any other combination or sequence of touches as described in, for example, U.S. Provisional Patent Application Ser. No. 62/607,816.

In some implementations, a user can use various contact patterns (e.g., different timings and/or intensities of detected contacts) to provide different inputs using the input device 120 of the wearable electronic device 100. Therefore, an input may be detected by the wearable electronic device 100 by the wearable electronic device 100 detecting a particular contact pattern (e.g., temporal pattern, spatial pattern, tactile pattern, combination of temporal, spatial, and, or tactile input patterns). For example, an input may be provided by a user to the wearable electronic device 100 using a soft tap gesture (e.g., slightly depressing actuation surface 122 using a weak force event). As another example, an input may be provided by a user to the wearable electronic device 100 using a hard tap gesture (e.g., greatly depressing actuation surface 122 using a strong force event). Similarly, multi-soft tap and multi-hard tap gestures (examples of tactile input) may be optionally detected by detecting a sequence of tap events by a user on actuation surface 122.

In some implementations, input device 120 may be a mechanical switch and include a depressible component that makes contact with a conductive element in response to a user applying a force to the depressible component. Upon release of the force applied by the user, the depressible component may thereafter return to a default position in response to an expansion of a spring or other biasing element. In some embodiments, the input device 120 may be electrically operated by sensing touch or proximity (e.g., by measuring capacitance of a user's finger).

In the implementation shown in FIGS. 1 to 3, control module 101 is removably mounted to body 102 and extends from body 102 such that the actuation surface 122 is exposed to and accessible by a finger of the wearer of the wearable electronic device 100.

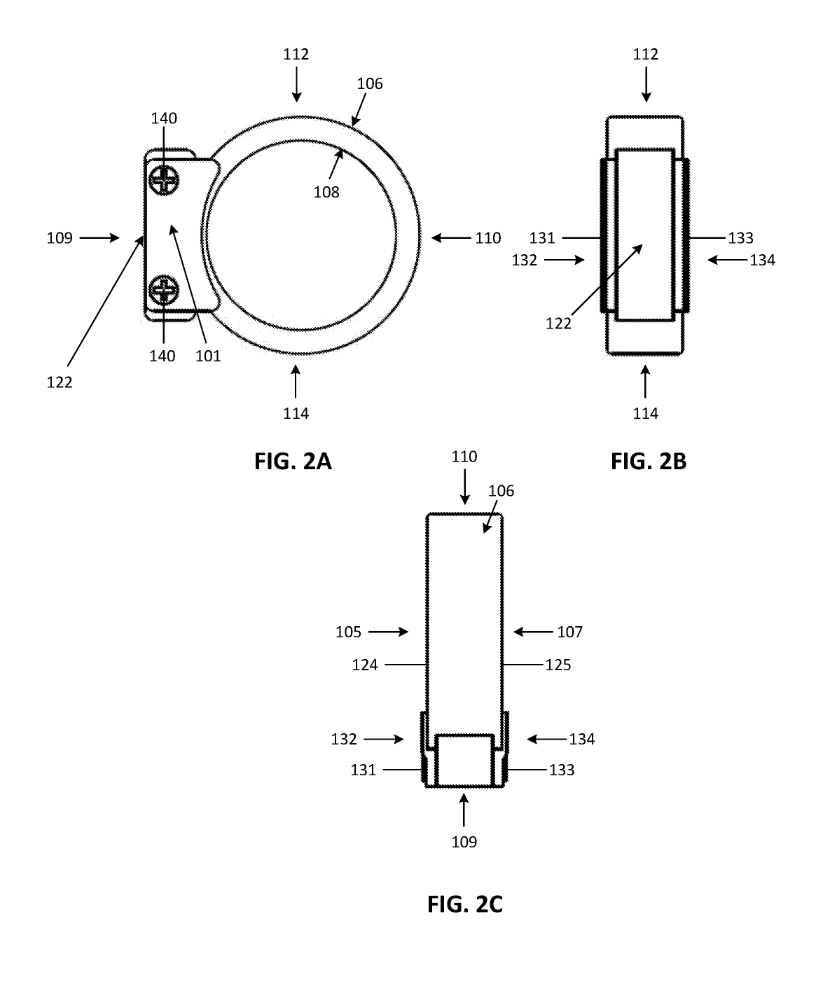

Turning to FIGS. 2A to 2C, illustrated therein are side, end and top views of the wearable electronic device 100 of FIG. 1 in a first configuration where the control module 101 is mounted to the body 102.

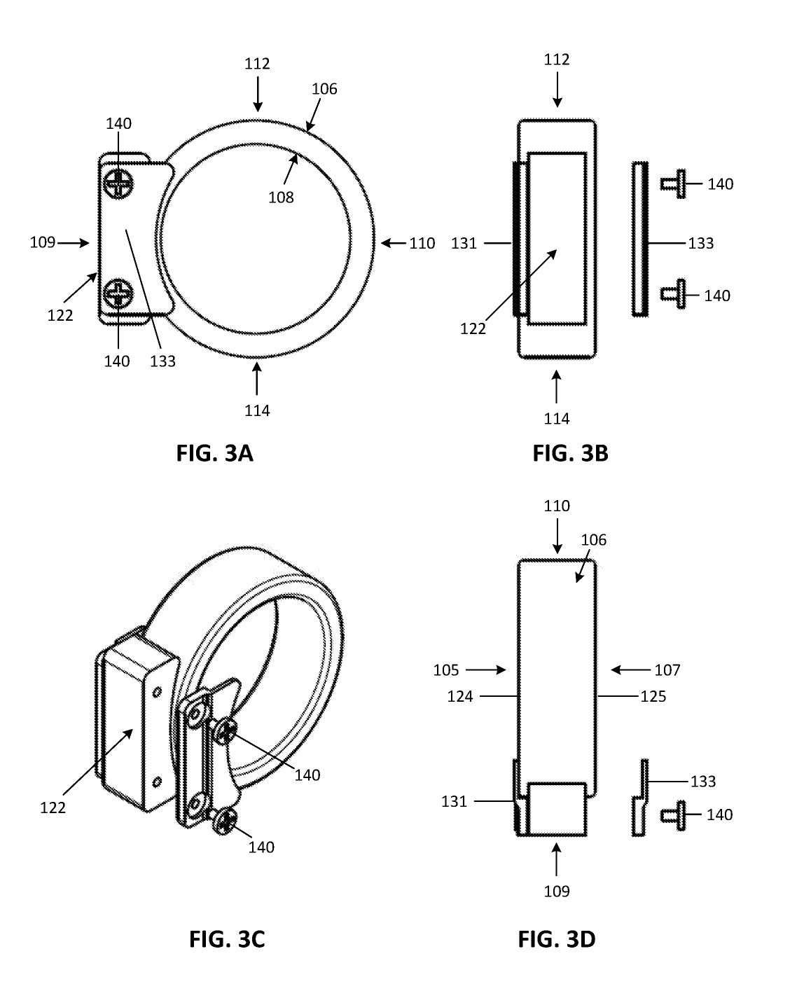

In this implementation, control module 101 includes a first mounting surface 131 and second mounting surface 133 opposed to first mounting surface 131. Mounting surfaces 131 and 133 extend from first and second sides 132 and 134 of the control module 101, respectively, towards aperture 104 of the body 102. FIGS. 3A to 3D, provide side, partially-exploded front, partially-exploded perspective, and partially-exploded top views of the wearable electronic device 100 of FIG. 1 showing the first mounting surface 131 as being integral with the control module 101 and the second mounting surface 133 being removable from the control module 101 for mounting the control module 101 to a body 102. When control module 101 is mounted to body 102, first mounting surface 131 rests against a first edge 124 of first side 105 of body 102 and second mounting surface 133 rests against a second edge 125 of second side 107. In the implementation shown in FIGS. 1 to 3, two fasteners 140 are inserted through fastener apertures in second mounting surface 133 and into the control module 101 for mounting the control module 101 against outer surface 106 of body 102. By tightening fasteners 140 the second mounting surface 133 can be draws towards the first mounting surface 131. As second mounting surface 133 rests against second edge 125 and first mounting surface 131 rest against first edge 124 when the fasteners 140 are tightened, the control module 101 is held by a friction fit to the body 102.

The skilled person will appreciate that fasteners 140 can be any appropriate fastener that releaseably mounts the control module 101 to the body 102. For instance, in FIGS. 1 to 3, fasteners 140 are shown as screws, however fasteners 140 may also be configured as snaps, rivets, bolts, etc.

The skilled person will also appreciate that in the implementations shown in FIGS. 1 to 3, body 102 can be any generic ring and the mounting surfaces 131, 133 can be sized and shaped to mount the control module to any sized generic ring.

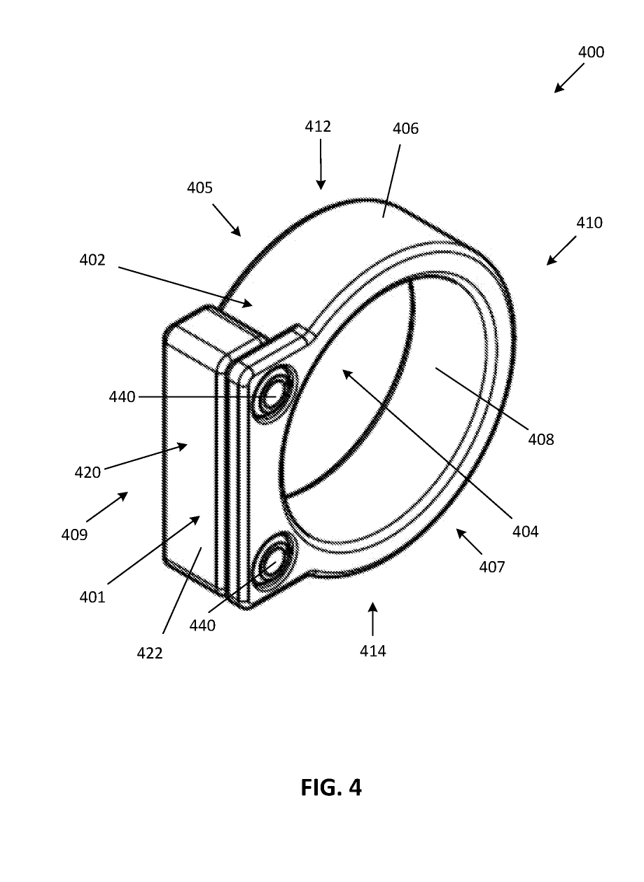

Referring now to FIGS. 4 to 6, illustrated therein is another implementation of a wearable electronic device having a removable control module. Wearable electronic device 400 has a body 402 and a control module 401 houses one or more electronic components (such as but not limited to a processor, memory, sensors, a charging member such as an inductive coil, electrical contacts, and/or recharging circuitry, etc. as described below). Again, body 402 defines an aperture 404 shaped and dimensioned to securely, removably, receive a first finger of a user.

Body 402 has a first side 405, a second side 407 opposed to the first side 405, a first end 409 and a second end 410 opposed to the first end 409, and a top portion 412 and a bottom portion 414 opposed to the top portion 412. Body 402 may have a generally annular shape and includes an outer surface 406 and an inner surface 408. The inner surface 408 is sized and/or shaped to securely, removably receive the first finger of the user. The inner surface 408 thereby rests against a portion of the first finger when the device 400 is worn by the user. Wearable electronic device 400 may be available in a variety of sizes for accommodating various finger sizes and/or various types of fingers.

In some implementations, the body 402 is made from a rigid or semi-rigid material such as a metal or a plastic. For instance, the body 402 may be made of gold, silver, platinum, or any other suitable metal.

In the implementation shown in FIGS. 4 to 6, control module 401 is removably mounted to body 402 and configured to rest against outer surface 406 when mounted on the body 402. Control module 401 includes one or more user input devices 420 for the wearable electronic device 400 to receive inputs from a user. The input device 420 can assume a wide variety of forms appropriate for actuation by a second finger of the user (e.g., by a finger other than the finger upon which the wearable electronic device is worn).

The input device 420 can be mechanical, electro-mechanical, and/or sensor (e.g., a membrane sensor)-based, and in more general terms provides an actuation surface 422 for receiving a user-applied actuation force or action.

A user can actuate the input device 420 by engaging and/or applying a force to the actuation surface 422. The input device 420 may be configured to be positively actuated only upon the contact of a certain percentage of the actuation surface 422 or certain minimum pressure on a pressure sensor-type switch to avoid unintended activation.

The input device 420 may be any shape or size while still providing ample control for a user with a finger (e.g., thumb of the same hand) other than the finger (e.g., index finger of the hand) upon which the device is worn. According to some implementations, the input device 420 can be sized and shaped to have the smallest size while still providing ample control for a user with a finger other than the finger upon which the device is worn.

An input can be provided to the wearable electronic device 400 by the user engaging input device 420. For instance, a user can engage the input device 420 when a finger of the user makes physical contact with input device 420 and actuates the input device 420. The physical actuation (e.g., manipulation) of the actuating surface 422 of the input device 420 is received and recognized by a processor (described below) of the device. In some embodiments, the pressure of the engagement and/or manipulation of the actuation surface 422 is translated by the processor into a computer-readable form. The processor then compares the engagement and or manipulation of the actuation surface by the user to a plurality of stored manipulations based on the input. The input may be, for example, a tap, or a double-tap (e.g., two successive touches or contacts within a given period of time, and an example of a temporal pattern), or any other combination or sequence of touches as described in, for example, U.S. Provisional Patent Application Ser. No. 62/607,816.

In some implementations, a user can use various contact patterns (e.g. different timings and/or intensities of detected contacts) to provide different inputs using the input device 420 of the wearable electronic device 400. Therefore, an input may be detected by the wearable electronic device 400 by the wearable electronic device 400 detecting a particular contact pattern (e.g., temporal pattern, spatial pattern, tactile pattern, combination of temporal, spatial, and, or tactile input patterns). For example, an input may be provided by a user to the wearable electronic device 400 using a soft tap gesture (e.g. slightly depressing actuation surface 422 using a weak force event). As another example, an input may be provided by a user to the wearable electronic device 400 using a hard tap gesture (e.g. greatly depressing actuation surface 422 using a strong force event). Similarly, multi-soft tap and multi-hard tap gestures (examples of tactile input) may be optionally detected by detecting a sequence of tap events by a user on actuation surface 422.

In some implementations, input device 420 may be a mechanical switch and include a depressible component that makes contact with a conductive element in response to a user applying a force to the depressible component. Upon release of the force applied by the user, the depressible component may thereafter return to a default position in response to an expansion of a spring or other biasing element. In some embodiments, the input device 420 may be electrically operated by sensing touch or proximity (e.g., by measuring capacitance of a user's finger).

In the implementation shown in FIGS. 4 to 6, control module 401 is removably mounted to a mounting surface 433 of the body 402 and that extends from body 402.

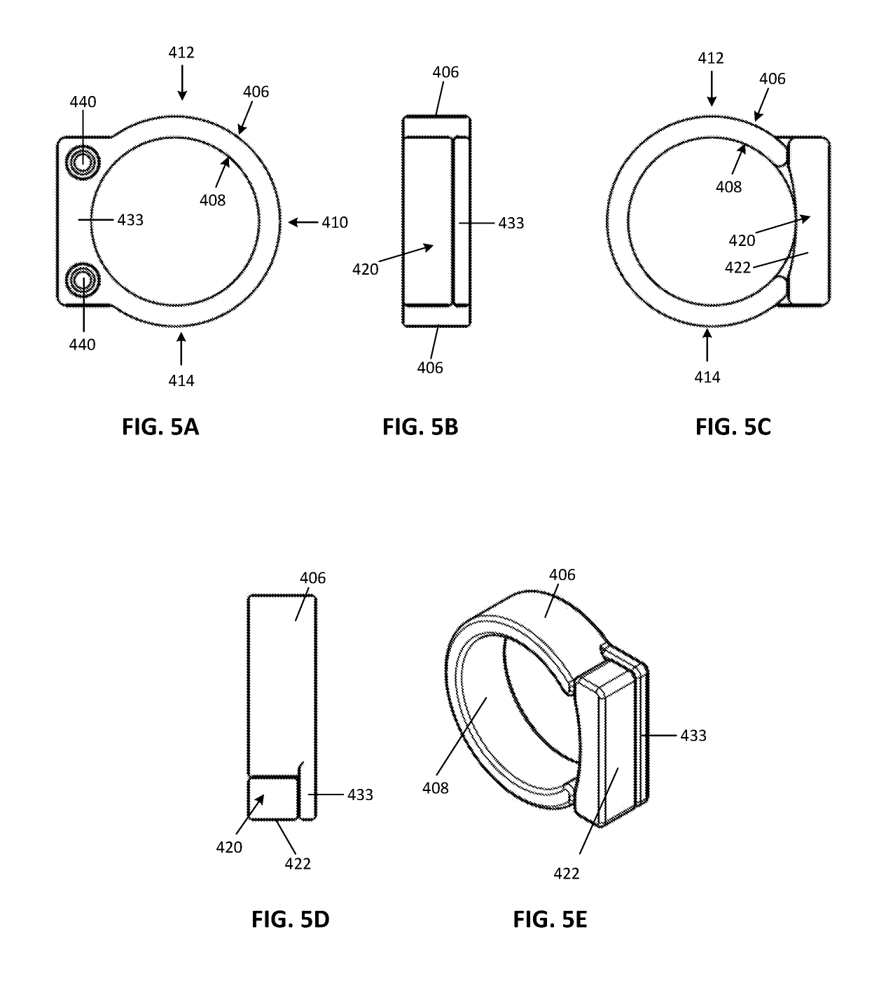

Turning now to FIGS. 5A to 5E, illustrated therein are a side view from second side 407, an end view from first end 409, a side view from first side 405, a top down view from top portion 412 and a perspective view from first side 405 of the wearable electronic device 400 of FIG. 4 in a first configuration, respectively, where the control module 401 is mounted to the body 402.

In this implementation, body 402 includes a mounting surface 433 that extends from outer surface 406 of body 402 in a direction towards first end 409. Mounting surface 433 generally has a planar shape and is sized and shaped to co-operate with a surface of the control module 401 to mount the control module 401 to the body 402.

Mounting surface 433 has two fastener apertures to receive fasteners for mounting the control module 401 to the body 402. In the embodiments shown in the drawings, two fasteners 440 are configured as being integral with the control module 401 and extending from control module 401 towards the mounting surface 433. Extensions 440 are sized and shaped to insert into the fastener apertures defined by mounting surface 433 to releaseably mount the control module 401 to the mounting surface 433. In the implementation shown in FIGS. 4 to 6, two extensions 440 are shown for releaseably mounting the control module 401 to the mounting surface 433. The skilled person will appreciate that one or more extensions may be used to releaseably couple the control module 401 to the body 402.

The skilled person will appreciate that extensions 440 may not be integral with control module 401 and may be any appropriate fastener that releaseably mounts the control module 401 to the body 402. For instance, extensions 440 may be screws, rivets, bolts, etc.

The skilled person will also appreciate that, unlike the implementation shown in FIGS. 1 to 3, in the implementation shown in FIGS. 4 to 6, body 402 is not a generic ring that is typically worn without a control module 401. Rather, body 402 is a ring that is intended to be worn with a control module 401 releaseably mounted thereon.

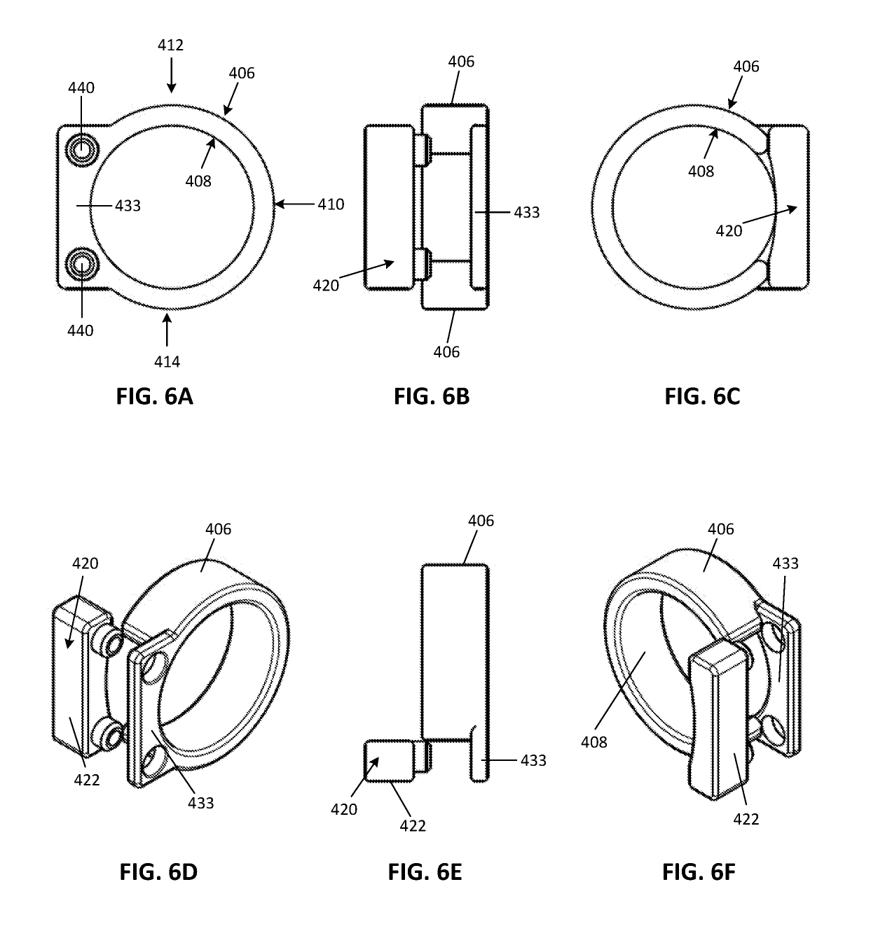

FIGS. 6A to 6F show a right side view from second side 407, a partially-exploded front view from first end 409, a left side view from first side 405, a partially-exploded right side perspective view from second side 407, a partially-exploded top view from top portion 412, and a partially-exploded left side perspective view from first side 405, respectively, of the wearable electronic device 400 of FIG. 4.

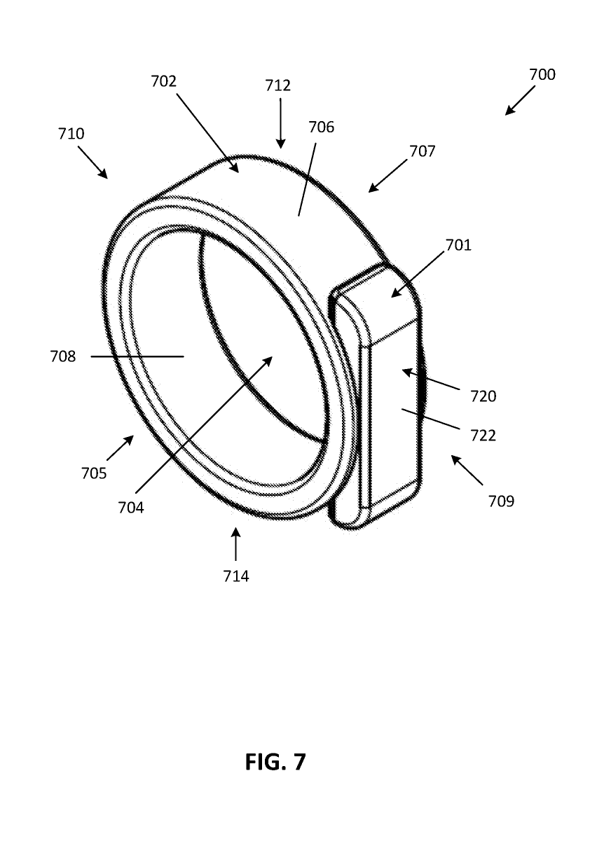

Referring now to FIGS. 7 to 9, illustrated therein is another implementation of a wearable electronic device having a removable control module. Wearable electronic device 700 has a body 702 and a control module 701 housing one or more electronic components (such as but not limited to a processor, memory, sensors, a charging member such as an inductive coil, electrical contacts, and/or recharging circuitry, etc. as described below). Again, body 702 defines an aperture 704 capable of receiving a first finger of a user.

Body 702 has a first side 705, a second side 707 opposed to the first side 705, a first end 709 and a second end 710 opposed to the first end 709, and a top portion 712 and a bottom portion 714 opposed to the top portion 712. Body 702 may generally have an annular shape and includes an outer surface 706 and an inner surface 708. The inner surface 708 is sized and/or shaped to securely, removably, receive the first finger of the user. The inner surface 708 thereby rests against a portion of the first finger when the device 700 is worn by the user. Wearable electronic device 700 may be available in a variety of sizes for accommodating various finger sizes and/or various types of fingers.

In some implementations, the body 702 is made from a rigid or semi-rigid material such as a metal or a plastic. For instance, the body 702 may be made of gold, silver, platinum, or any other suitable metal.

In the implementation shown in FIGS. 7 to 9, control module 701 is removably mounted to body 702. Control module 701 includes one or more user input devices 720 for the wearable electronic device 700 to receive inputs from a user. The input device 720 can assume a wide variety of forms appropriate for actuation by a second finger of a user (e.g., by a finger other than the finger upon which the wearable electronic device is worn).

The input device 720 can be mechanical, electro-mechanical, and/or sensor (e.g., a membrane sensor)-based, and in more general terms provides an actuation surface 722 for receiving a user-applied actuation force or action.

A user can actuate the input device 720 by engaging and/or applying a force to the actuation surface 722. The input device 720 may be configured to be positively actuated only upon the contact of a certain percentage of the actuation surface 722 or certain minimum pressure on a pressure sensor-type switch to avoid unintended activation.

The input device 720 may be any shape or size while still providing ample control for a user with a finger other than the finger upon which the device is worn. According to some implementations, the input device 720 can be sized and shaped to have the smallest size while still providing ample control for a user with a finger other than the finger upon which the device is worn.

An input can be provided to the wearable electronic device 700 by the user engaging input device 720. For instance, a user can engage the input device 120 when a finger of the user makes physical contact with input device 120 and actuates the input device 720. The physical actuation (e.g., manipulation) of the actuating surface 722 of the input device 720 is received and recognized by a processor (described below) of the device. In some implementations, the pressure of the engagement and/or manipulation of the actuation surface 722 is translated by the processor into a computer-readable form. The processor then compares the engagement and or manipulation of the actuation surface by the user to a plurality of stored manipulations based on the input. The input may be, for example, a tap, or a double-tap (e.g., two successive touches or contacts within a given period of time, and an example of a temporal pattern), or any other combination or sequence of touches as described in, for example, U.S. Provisional Patent Application Ser. No. 62/607,816.

In some embodiments, a user can use various contact patterns (e.g., different timings and/or intensities of detected contacts) to provide different inputs using the input device 720 of the wearable electronic device 700. Therefore, an input may be detected by the wearable electronic device 700 by the wearable electronic device 700 detecting a particular contact pattern (e.g., temporal pattern, spatial pattern, tactile pattern, combination of temporal, spatial, and, or tactile input patterns). For example, an input may be provided by a user to the wearable electronic device 700 using a soft tap gesture (e.g., slightly depressing actuation surface 722 using a weak force event). As another example, an input may be provided by a user to the wearable electronic device 700 using a hard tap gesture (e.g., greatly depressing actuation surface 722 using a strong force event). Similarly, multi-soft tap and multi-hard tap gestures (examples of tactile input) may be optionally detected by detecting a sequence of tap events by a user on actuation surface 722.

In some implementations, input device 720 may be a mechanical switch and include a depressible component that makes contact with a conductive element in response to a user applying a force to the depressible component. Upon release of the force applied by the user, the depressible component may thereafter return to a default position in response to an expansion of a spring or other biasing element. In some embodiments, the input device 720 may be electrically operated by sensing touch or proximity (e.g. by measuring capacitance of a user's finger).

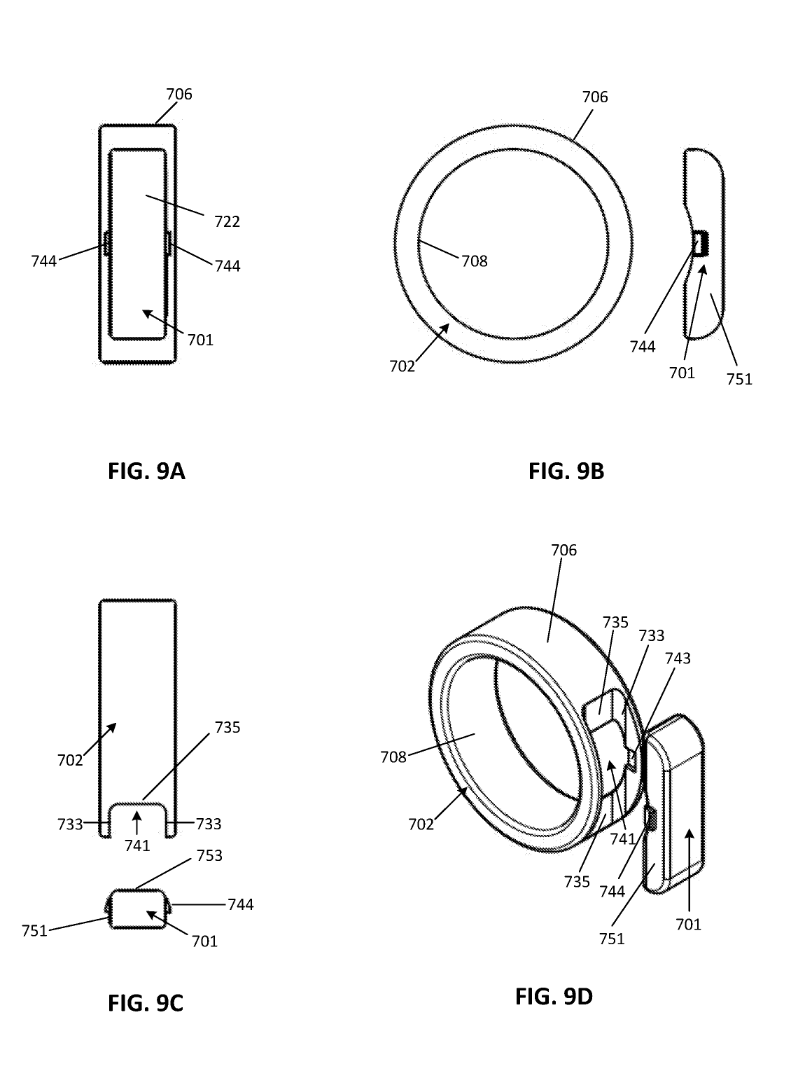

In the implementation shown in FIGS. 7 to 9, control module 701 is removably mounted to mounting surfaces 733 and 735 of the body 702 (see FIG. 9, described below).

In the implementation shown in FIGS. 7 to 9, aperture 741 is shown on first end 709, however, the skilled person will understand that aperture 741 may also be on second end 710, top portion 712 or bottom portion 714.

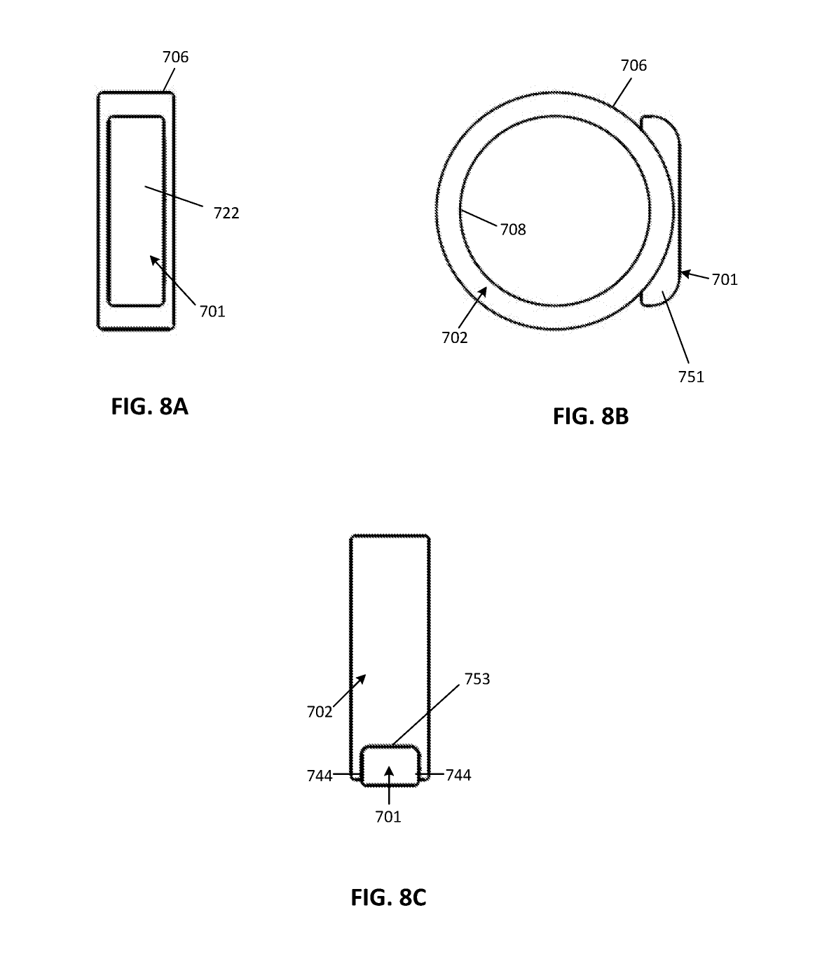

Turning now to FIGS. 8A to 8C, illustrated therein are an end view from first end 709, a side view from first side 705 and a top down view from top portion 712 of the wearable electronic device 700 of FIG. 7 in a first configuration, respectively, where the control module 701 is mounted to the body 702.

FIGS. 9A to 9D show front view from first end 709, a partially-exploded left side view from first side 705, a partially-exploded top view from top portion 712, and a partially-exploded left side perspective view from first side 705, respectively, of the wearable electronic device 700 of FIG. 7.

In this implementation, body 702 includes at least two side mounting surfaces 733 and at least two end mounting surfaces 735. Side mounting surfaces 733 are inner surfaces defined by an aperture 741 extending between inner surface 708 and outer surface 706 of the body 702 in an outward direction between second end 710 and first end 709. Side mounting surfaces 733 also extend vertically between top portion 712 and bottom portion 714 and are generally coplanar with planes defined by first side 705 and second side 707. Side mounting surfaces 733 are sized and shaped to co-operate with side surfaces 751 of control module 701 to receive control module 701 thereon.

End mounting surfaces 735 are also inner surfaces defined by aperture 741 extending between inner surface 708 and outer surface 706 of the body 702 in an outward direction between bottom portion 714 and top portion 712. End mounting surfaces 735 are sized and shaped to receive at least a portion of an inner surface 753 of the control module 701. For instance, as shown specifically in FIGS. 9C and 9D, end mounting surfaces 735 are sized and shaped for a portion of inner surface 753 of control module 701 to rest against end mounting surfaces 735 when control module 701 is mounted to the body 702.

Side mounting surfaces 733 may include one or more recesses 743 for retaining control module 701. For instance, recesses 743 may be recess recessed into from inner surface 708 towards outer surface 706 of body 702. Control module 701 is retained by body 702 by end mounting surface 735 may be sized and shaped to support an inner surface of the control module 701 thereon when the control module 701 is mounted to the body 702.

As shown in the Figures, control module 701 may be sized and shaped to extend from the outer surface 706 of the body 702, for instance in a direction towards the top and/or bottom ends 712, 714, respectively. The control module 701 may also be sized and shaped such that surface 722 of control module 701 is coincident or “flush” with (e.g., outer surface 722 is approximately “tangent” with the outer surface 706 of body 702—see FIG. 8B).

As shown, control module 701 has extensions 744 sized and shaped to co-operate with the recesses 743 of the body 702 to form a friction or interference fit for mounting the control module 701 to the body 702. Control module 701 is releaseably mounted to body 702 such that extensions 744 secure the control module 701 to the body 702 when the wearable electronic device 700 is won by a user and are easily removable from recesses 743 once the wearable electronic device 700 has been removed from a finger of a user.

For instance, extensions 744 may be tabs that are biased to extend from side surfaces 751 of the control module 701. As a user slidingly engages control module 701 into aperture 741 (e.g., in a direction towards aperture 704), extensions 744 may be depressed by side mounting surfaces 733. As the control module 701 is further slid towards aperture 704, the extensions 744 align with the recesses 743 and are biased back to their extended position. Accordingly, in the mounted position, the extensions 744 inhibit movement of the control module in a direction away from the aperture 704 and the control module 701 rests against the side mounting surfaces 733 and the end mounting surfaces 735

The skilled person will appreciate that extensions 440 may not be integral with control module 401 and may be any suitable fastener for releaseably mounting the control module 401 to the body 402. For instance, extensions 440 may be screws, rivets, bolts, etc.

The skilled person will also appreciate that, unlike the implementation shown in FIGS. 1 to 3, in the implementation shown in FIGS. 7 to 9, body 702 is not a generic ring that is typically worn without a control module 701. Rather, body 702 is a ring that is to be worn with a control module 701 releaseably mounted thereon.

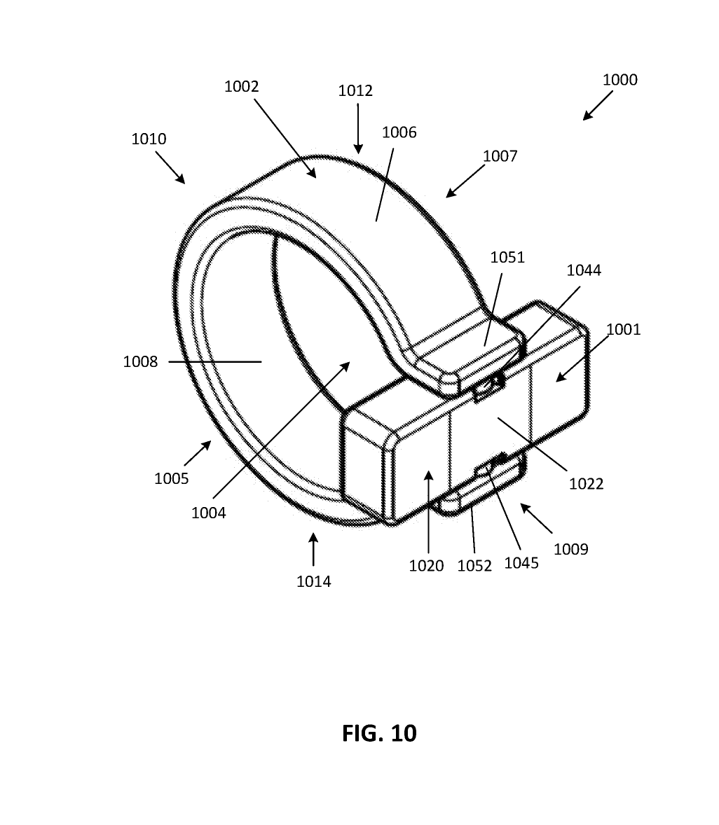

Turning now to FIGS. 10 to 12, illustrated therein is another implementation of a wearable electronic device 1000 having a removable control module 1001. Wearable electronic device 1000 has a body 1002 and a control module 1001 that house one or more electronic components (such as but not limited to a processor, memory, sensors, a charging member such as an inductive coil, electrical contacts, and/or recharging circuitry, etc. as described below). Again, body 1002 defines an aperture 1004 securely, removably, receive a first finger of a user.

Body 1002 has a first side 1005, a second side 1007 opposed to the first side 1005, a first end 1009 and a second end 1010 opposed to the first end 1009, and a top portion 1012 and a bottom portion 1014 opposed to the top portion 1012. Body 1002 generally has an annular shape and includes an outer surface 1006 and an inner surface 1008. The inner surface 1008 is sized and/or shaped to securely, removably, receive the first finger of the user. The inner surface 1008 thereby rests against a portion of the first finger of the user when the device 1000 is worn by the user. Wearable electronic device 1000 may be available in a variety of sizes for accommodating various finger sizes and/or various types of fingers.

In some implementations, the body 1002 is made from a rigid or semi-rigid material such as a metal or a plastic. For instance, the body 1002 may be made of gold, silver, platinum, or any other suitable metal.

In the implementation shown in FIGS. 10 to 12, control module 1001 is removably mounted to body 1002. Control module 1001 includes one or more user input devices 1020 for the wearable electronic device 1000 to receive inputs from a user. The input device 1020 can assume a wide variety of forms appropriate for actuation by a user's finger (e.g., by a finger other than the finger upon which the wearable electronic device is worn).

The input device 1020 can be mechanical, electro-mechanical, and/or sensor (e.g., a membrane sensor)-based, and in more general terms provides an actuation surface 1022 for receiving a user-applied actuation force or action.

A user can actuate the input device 1020 by engaging and/or applying a force to the actuation surface 1022. The input device 1020 may be configured to be positively actuated only upon the contact of a certain percentage of the actuation surface 1022 or certain minimum pressure on a pressure sensor-type switch to avoid unintended activation.

The input device 1020 may be any shape or size while still providing ample control for a user with a second finger (e.g., thumb of the same hand) other than the first finger (e.g., index finger of the hand) upon which the device is worn. According to some embodiments, the input device 1020 can be sized and shaped to have the smallest size while still providing ample control for a user with a finger other than the finger upon which the device is worn.

An input can be provided to the wearable electronic device 1000 by the user engaging input device 1020. For instance, a user can engage the input device 120 when a finger of the user makes physical contact with input device 120 and actuates the input device 1020. The physical actuation (e.g., manipulation) of the actuating surface 1022 of the input device 1020 is received and recognized by a processor (described below) of the device. In some embodiments, the pressure of the engagement and/or manipulation of the actuation surface 1022 is translated by the processor into a computer-readable form. The processor then compares the engagement and or manipulation of the actuation surface by the user to a plurality of stored manipulations based on the input. The input may be, for example, a tap, or a double-tap (e.g., two successive touches or contacts within a given period of time, and an example of a temporal pattern), or any other combination or sequence of touches as described in, for example, U.S. Provisional Patent Application Ser. No. 62/607,816.

In some implementations, a user can use various contact patterns (e.g., different timings and/or intensities of detected contacts) to provide different inputs using the input device 1020 of the wearable electronic device 1000. Therefore, an input may be detected by the wearable electronic device 1000 by the wearable electronic device 1000 detecting a particular contact pattern (e.g., temporal pattern, spatial pattern, tactile pattern, combination of temporal, spatial, and, or tactile input patterns). For example, an input may be provided by a user to the wearable electronic device 1000 using a soft tap gesture (e.g., slightly depressing actuation surface 1022 using a weak force event). As another example, an input may be provided by a user to the wearable electronic device 1000 using a hard tap gesture (e.g., greatly depressing actuation surface 1022 using a strong force event). Similarly, multi-soft tap and multi-hard tap gestures (examples of tactile input) may be optionally detected by detecting a sequence of tap events by a user on actuation surface 1022.

In some implementations, input device 1020 may be a mechanical switch and include a depressible component that makes contact with a conductive element in response to a user applying a force to the depressible component. Upon release of the force applied by the user, the depressible component may thereafter return to a default position in response to an expansion of a spring or other biasing element. In some embodiments, the input device 1020 may be electrically operated by sensing touch or proximity (e.g., by measuring capacitance of a user's finger).

In the implementation shown in FIGS. 10 to 12, control module 1001 is removably mounted to upper and lower projections 1051, 1052, respectively, via extensions 1044, 1045, extending from respectively, of body 1002.

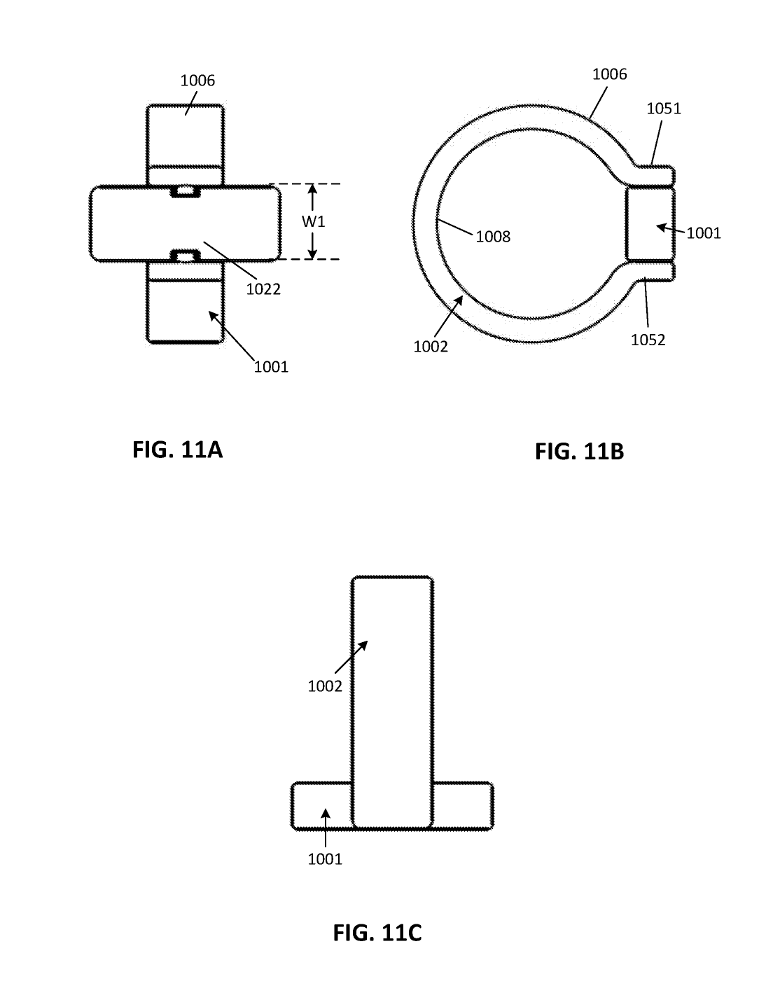

FIGS. 11A to 11C show an end view from first end 1009, a side view from first side 1005 and a top down view from top portion 1012 of the wearable electronic device 1000 of FIG. 10 in a first configuration, respectively, where the control module 701 is mounted to the body 702.

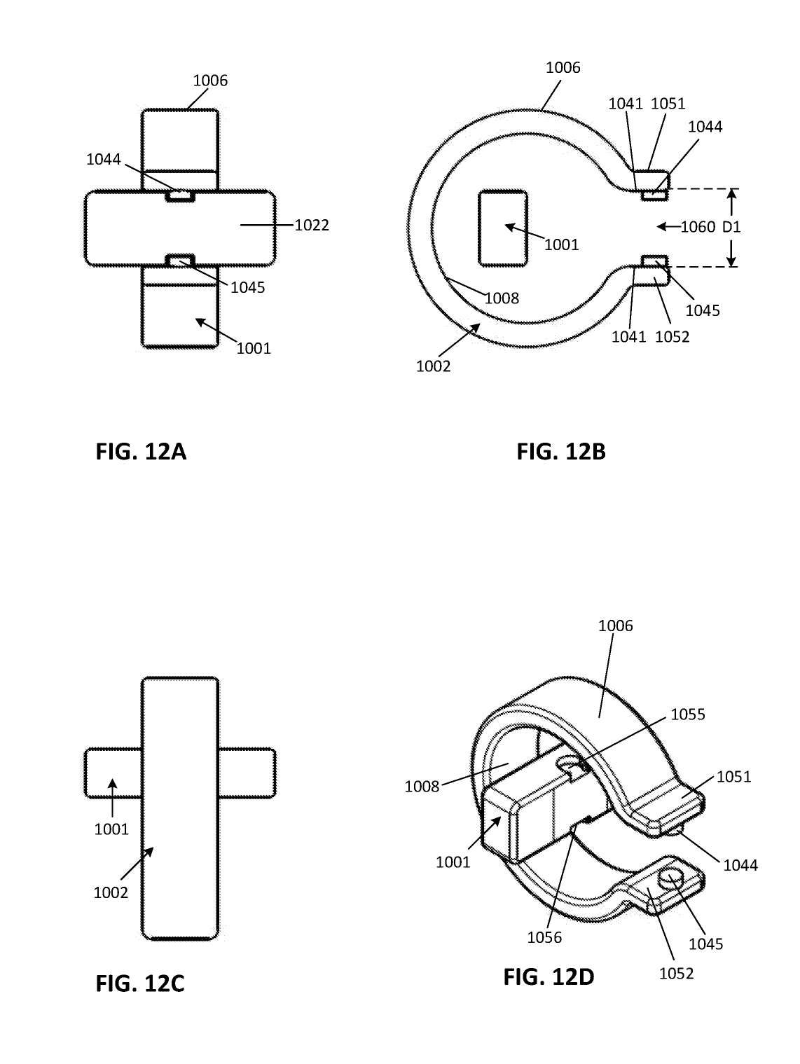

Body 1002 of wearable electronic device 1000 is discontinuous and generally has an annular shape. At first end 1009 of the wearable electronic device 1000, an upper projection 1051 and a lower projection 1052 are spaced apart from each other to define an opening 1060 (see FIG. 12B). Upper projection 1051 and a lower projection 1052 extend away from aperture 1004 and are spaced apart from each other by a distance D1 (see FIG. 12B) approximately equal to a width W1 of control module 1001 (see FIG. 11A).

Upper projection 1051 and lower projection 1052 each provide an inner mounting surface 1041 to releaseably mount control module 1001 to body 1002. Inner mounting surfaces 1041 each comprise a projection 1044 sized and shaped to be slidingly received into a recess surfaces 1055, 1056 in top and bottom of the control module 1001. To releaseably mount the control module 1001 to the body 1002, a user can insert the control module 1001 into the aperture 1004 and then slide the control module towards opening 106 with the recesses 1055, 1056 aligned with projections 1044, 1045, respectively. As recesses 1055, 1056 are sized and shaped to receive (e.g., closely receive) to the size and shape of the projections 1044, 1045, respectively, projections 1044, 1045 can be slidingly received (e.g., closely received) in recesses 1055, 1056 respectively. Recesses 1055, 1056 can inhibit movement of the control module 1001 in a direction away from the aperture 1004 when the user is wearing the wearable electronic device 1000 to securely mount the control module 1001 to the body 1002.

Projections 1044 and 1045 can be any shape and size to be slidingly received by recesses 1055 and 1056, respectively. In the implementations shown in the Figures, projections 1044 and 1045 have a round (e.g., circular) shape. In this implementation, when projections 1044 and 1045 are axially aligned with each other, projections 1044 and 1045 may provide for the control module 1001 to rotate about an axis extending between the projections 1044 and 1045 when mounted to the body 1002. In other implementations, projections 1044 and 1045 may not be axially aligned and control module 1001 may not rotate when mounted to the body 1002.

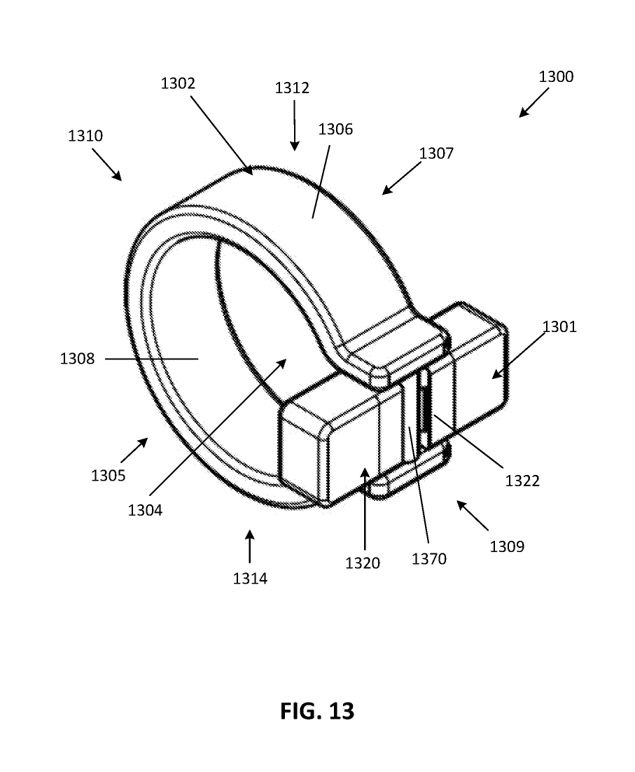

It should be understood that projections 1044 and 1045 being spaced apart from each other and recesses 1055 and 1056 being positioned on the top and bottom surfaces, respectively, of the control module 1001 may provide for input device 1020 to have a single, continuous actuation surface 1022 via which inputs are provided to the control module 1001. In other implementations described herein, for example but not limited to the implementation shown in FIGS. 13 to 15, more than one actuation surface may be provided (e.g., two or more actuation surfaces) to provide inputs to the input device.

FIGS. 12A to 12D show a front view from first end 1009, a partially-exploded left side view from first side 1005, a partially-exploded top view from top portion 1012, and a partially-exploded left side perspective view from first side 1005, respectively, of the wearable electronic device 1000 of FIG. 10.

The skilled person will appreciate that, unlike the implementation shown in FIGS. 1 to 3, in the implementation shown in FIGS. 10 to 12, body 1002 is not a generic ring that is typically worn without a control module 1001. Rather, body 1002 is a ring that is to be worn with a control module 1001 releaseably mounted thereon.

Turning now to FIGS. 13 to 15, illustrated therein is another implementation of a wearable electronic device 1300 having a removable control module 1301. Wearable electronic device 1300 has a body 1302 and a control module 1301 that houses one or more electronic components (such as but not limited to a processor, memory, sensors, a charging member such as an inductive coil, electrical contacts, and/or recharging circuitry, etc. as described below), that body 1302 defines an aperture 1304 shaped and dimensioned to receive a first finger of a user.

Body 1302 has a first side 1305, a second side 1307 opposed to the first side 1305, a first end 1309 and a second end 1310 opposed to the first end 1309, and a top portion 1312 and a bottom portion 1314 opposed to the top portion 1312. Body 1302 generally has an annular shape and includes an outer surface 1306 and an inner surface 1308. The inner surface 1308 is sized and/or shaped to securely, removably, receive the first finger of the user, for example the ring finger. The inner surface 1308 thereby rests against a portion of the first finger of the user when the device 1300 is worn by the user. Wearable electronic device 1300 may be available in a variety of sizes for accommodating various finger sizes and/or various types of fingers.

In some implementations, the body 1302 is made from a rigid or semi-rigid material such as a metal or a plastic. For instance, the body 1302 may be made of gold, silver, platinum, or any other suitable metal.

In the implementation shown in FIGS. 13 to 15, control module 1301 is removably mounted to body 1302. Control module 1301 includes one or more user input devices 1320 for the wearable electronic device 1300 to receive inputs from a user. The input device 1320 can assume a wide variety of forms appropriate for actuation by a second finger of the user (e.g., by a finger other than the finger upon which the wearable electronic device is worn).

The input device 1320 can be mechanical, electro-mechanical, and/or sensor (e.g., a membrane sensor)-based, and in more general terms provides an actuation surface 1322 for receiving a user-applied actuation force or action.

A user can actuate the input device 1320 by engaging and/or applying a force to the actuation surface 1322. The input device 1320 may be configured to be positively actuated only upon the contact of a certain percentage of the actuation surface 1322 or certain minimum pressure on a pressure sensor-type switch to avoid unintended activation.

The input device 1320 may be any shape or size while still providing ample control for a user with a finger other than the finger upon which the device is worn. According to some embodiments, the input device 1320 can be sized and shaped to have the smallest size while still providing ample control for a user with a second finger (e.g., thumb of the same hand) other than the first finger (e.g., index finger of the hand) upon which the device is worn.

An input can be provided to the wearable electronic device 1300 by the user engaging input device 1320. For instance, a user can engage the input device 120 when a finger of the user makes physical contact with input device 120 and actuates the input device 1320. The physical actuation (e.g., manipulation) of the actuating surface 1322 of the input device 1320 is received and recognized by a processor (described below) of the device. In some embodiments, the pressure of the engagement and/or manipulation of the actuation surface 1322 is translated by the processor into a computer-readable form. The processor then compares the engagement and or manipulation of the actuation surface by the user to a plurality of stored manipulations based on the input. The input may be, for example, a tap, or a double-tap (e.g., two successive touches or contacts within a given period of time), or any other combination or sequence of touches as described in, for example, U.S. Provisional Patent Application Ser. No. 62/607,816.

In some implementations, a user can use various contact patterns (e.g., different timings and/or intensities of detected contacts) to provide different inputs using the input device 1320 of the wearable electronic device 1300. Therefore, an input may be detected by the wearable electronic device 1300 by the wearable electronic device 1300 detecting a particular contact pattern (e.g., temporal pattern, spatial pattern, tactile pattern, combination of temporal, spatial, and, or tactile input patterns). For example, an input may be provided by a user to the wearable electronic device 1300 using a soft tap gesture (e.g., slightly depressing actuation surface 1322 using a weak force event). As another example, an input may be provided by a user to the wearable electronic device 1300 using a hard tap gesture (e.g., greatly depressing actuation surface 1322 using a strong force event). Similarly, multi-soft tap and multi-hard tap gestures (examples of tactile input) may be optionally detected by detecting a sequence of tap events by a user on actuation surface 1322.

In some implementations, input device 1320 may be a mechanical switch and include a depressible component that makes contact with a conductive element in response to a user applying a force to the depressible component. Upon release of the force applied by the user, the depressible component may thereafter return to a default position in response to an expansion of a spring or other biasing element. In some embodiments, the input device 1320 may be electrically operated by sensing touch or proximity (e.g., by measuring capacitance of a user's finger).

In the implementation shown in FIGS. 13 to 15, control module 1301 is removably mounted to upper and lower projections 1351, 1352, respectively, via extensions 1344, 1345, extending from respectively, of body 1302.

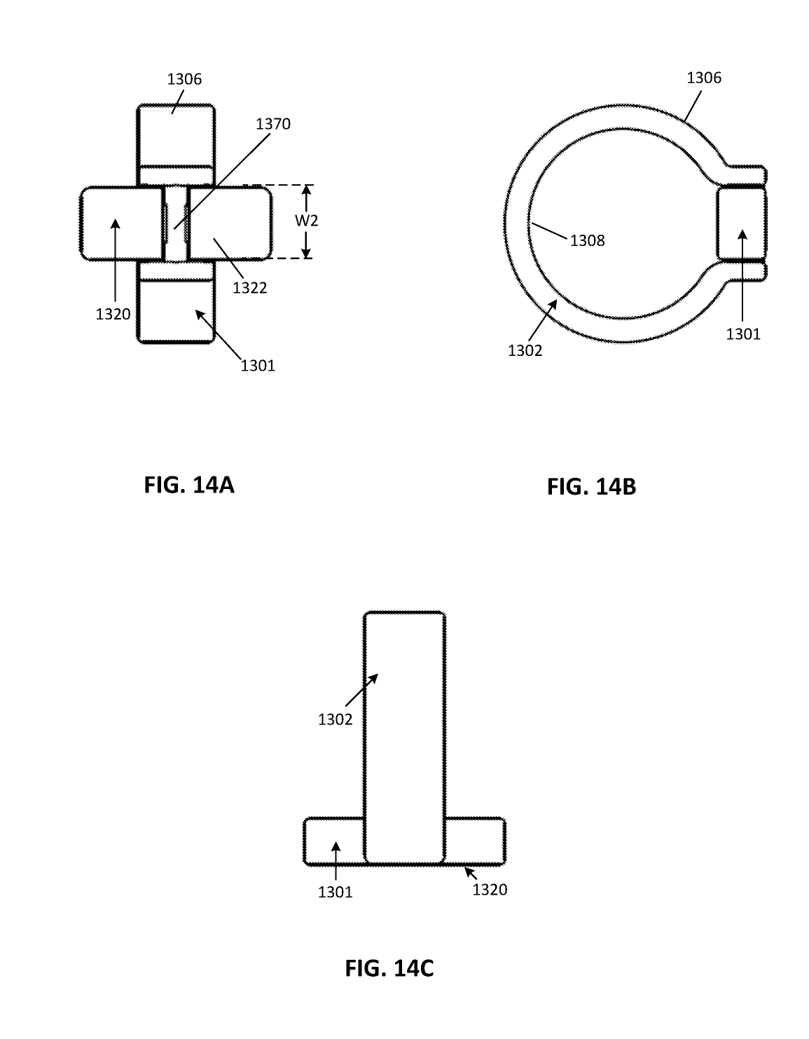

FIGS. 14A to 14C show an end view from first end 1309, a side view from first side 1305 and a top down view from top portion 1312 of the wearable electronic device 1300 of FIG. 13 in a first configuration, respectively, where the control module 1301 is removably mounted to the body 1302.

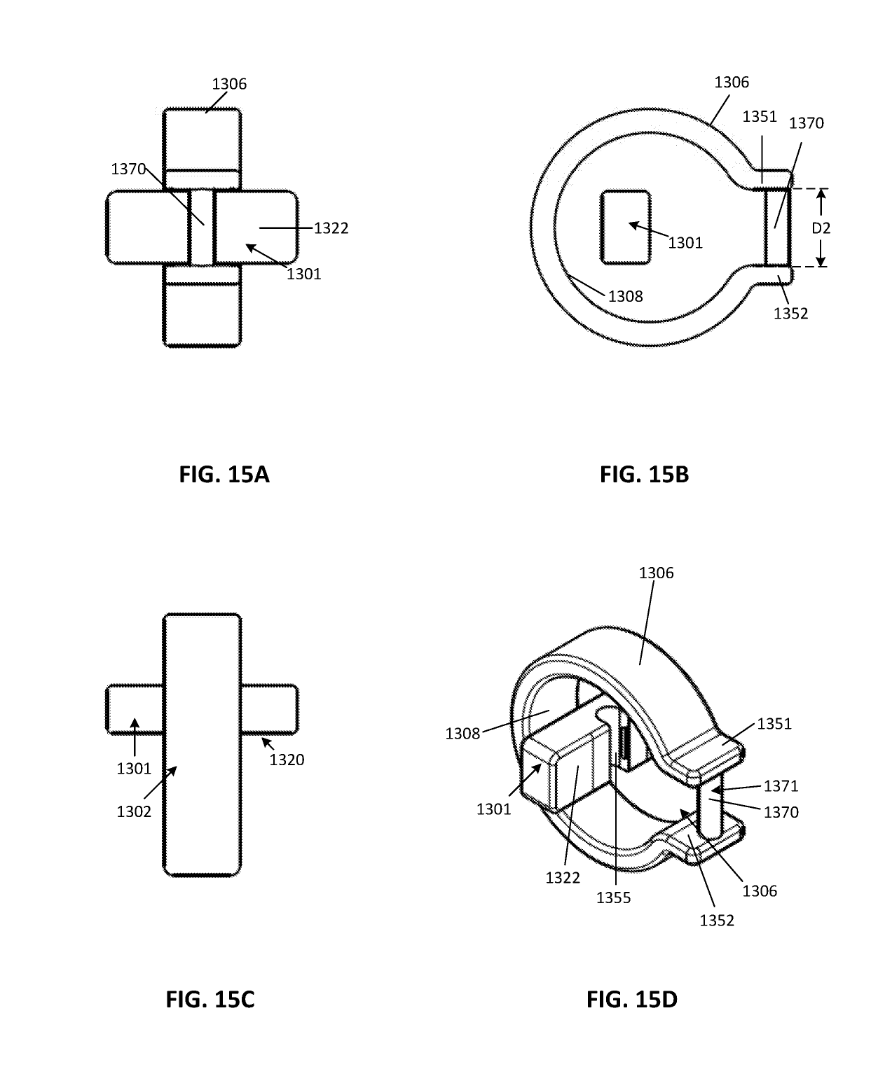

Similarly to the body 1002 of wearable electronic device 1000 previously described, body 1302 of wearable electronic device 1300 is discontinuous and generally has an annular shape. However, at first end 1309 of the wearable electronic device 1300, an upper projection 1351 and a lower projection 1352 are spaced apart from each other by a post 1370. Upper projection 1351 and a lower projection 1352 extend away from aperture 1304 and are spaced apart from each other by a distance D2 (see FIG. 15B) approximately equal to a width W2 of control module 1301 (see FIG. 14A).

Post 1370 provides a mounting surface 1371 for releaseably mounting control module 1301 to body 1302. Mounting surface 1371 is sized and shaped to be slidingly received into a recess 1355 in the front face of control module 1301 (see FIG. 15D). To releaseably mount the control module 1301 to the body 1302, a user can insert the control module 1301 into the aperture 1304 and then slide the control module 1301 towards opening 1306 with the recess 1035 aligned with post 1370. As recess 1355 is sized and shaped to conform to the size and shape of the post 1370, post 1370 can be slidingly received in recess 1355. Recess 1355 can inhibit movement of the control module 1301 in a direction away from the aperture 1304 when the user is wearing the wearable electronic device 1300 to securely mount the control module 1301 to the body 1302. Further, as shown in the Figures, post 1370 can have a rounded (e.g., circular or arcuate profile) shape to provide for control module 130 to rotate about an axis defined by the post 1370.

FIGS. 15A to 15D show a front view from first end 1309, a partially-exploded left side view from first side 1305, a partially-exploded top view from top portion 1312, and a partially-exploded left side perspective view from first side 1305, respectively, of the wearable electronic device 1000 of FIG. 13.

The skilled person will appreciate that, unlike the embodiment shown in FIGS. 1 to 3, in the embodiment shown in FIGS. 13 to 15, body 1302 is not a generic ring that is typically worn without a control module 1301. Rather, body 1302 is a ring that is intended to be worn with a control module 1301 releaseably mounted thereon.

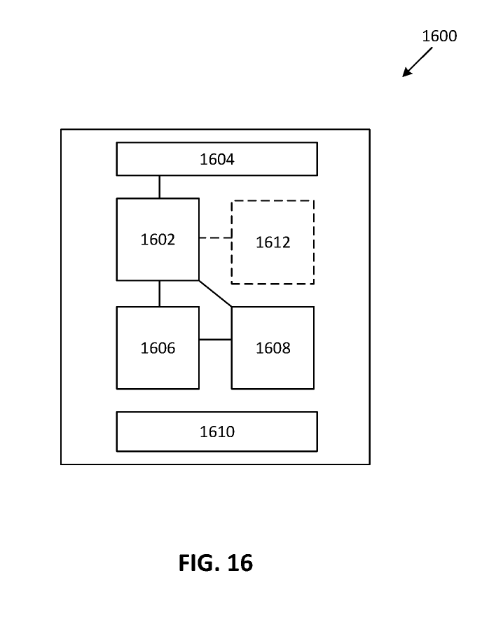

FIG. 16 is a block diagram illustrating a wearable electronic device 1600 with a removable control module in accordance with at least some of the illustrated and afore described implementations. Device 1600 includes one or more nontransitory computer- or processor-readable storage media, for example memory 1602. Device 1600 includes one or more processing units (CPUs) 1604, radios 1606 and associated antenna, and an input/output (I/O) subsystem 1608. Device 1600 optionally includes a power system 1610. Wearable electronic device 1600 optionally includes one or more sensors 1612.

Memory 1602 optionally includes high-speed random access memory and optionally also includes non-volatile memory, such as one or more magnetic disk storage devices, flash memory devices, or other non-volatile solid-state memory devices. Access to memory 1602 by other components of wearable electronic device 1600, such as CPU(s) 1604 is, optionally, controlled by a memory controller (not shown).

The one or more processors 1604 run or execute various software programs and/or sets of instructions stored in memory 1602 to perform various functions for wearable electronic device 1600 and to process data.

The radio(s) 1606 receives and sends radio frequency and/or microwave signals, also called electromagnetic signals. Radio 1606 converts electrical signals to/from electromagnetic signals and communicates with communications networks and other communications devices via the electromagnetic signals. Radio 1606 optionally includes circuitry for performing these functions, including but not limited to an antenna system, a wireless transceiver, one or more amplifiers, a tuner, one or more oscillators, a digital signal processor, a CODEC chipset, a subscriber identity module (SIM) card, memory, and so forth. Radio 1606 optionally communicates via one or more networks, such as the Internet, an intranet and/or a wireless network, such as a cellular telephone network, a wireless local area network (LAN) and/or a metropolitan area network (MAN), and other devices by wireless communication via any suitable network protocol.

I/O subsystem 1608 couples input/output peripherals of wearable electronic device 1600, such as input device 1620 and other input or control devices, with a peripherals interface (not shown). I/O subsystem 1608 includes a controller for the input device 1620.

Power system 1610 generally provides electrical power to the various components of the wearable electronic device 1600. Power system 1610 optionally includes a power management system, one or more power sources (e.g., primary battery cells, secondary battery cells, super- or ultra-capacitors, fuel cells), a recharging system, a power failure detection circuit, a power converter or inverter, a power status indicator (e.g., a light-emitting diode (LED)) and any other components associated with the generation, management and distribution of power in portable devices. The recharging system may be configured to receive wired power (from, e.g., a micro-USB charger) or wireless power transmitted via electromagnetic waves and to provide the wired power to the one or more power sources.

Wearable electronic device 1600 optionally also includes one or more accelerometers, gyroscopes, and/or magnetometers (e.g., as part of an inertial measurement unit (IMU)) vibration, shock, impact, and any other appropriate inertial sensors (herein referred to as impact sensors) for obtaining information concerning the position (e.g., attitude) acceleration, orientation, angular velocity, and/or vibration of the wearable electronic device. In some embodiments, these sensors can be coupled with a peripherals interface (not shown)

It should be appreciated that wearable electronic device 1600 is only one example of a wearable electronic device, and that wearable electronic device 1600 optionally has more or fewer components than shown, optionally combines two or more components, or optionally has a different configuration or arrangement of the components. The various components shown in FIG. 16 are implemented in hardware, software, firmware, or a combination thereof, including one or more signal processing and/or application specific integrated circuits.

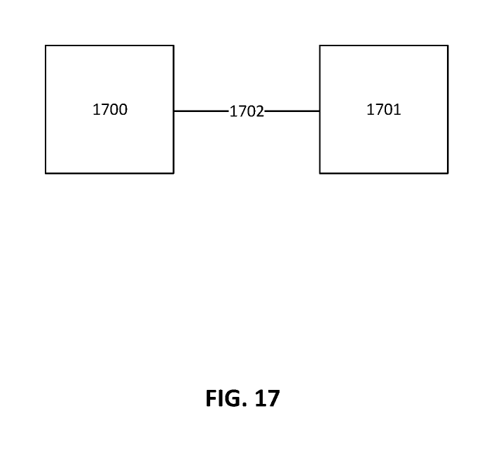

FIG. 17 is a block diagram illustrating a system of an external electronic device 1701 communicating with a wearable electronic device 1700 in accordance with embodiments described herein, according to at least one implementation.

External electronic device 1701 may be any external electronic device capable of being controlled by the wearable electronic device 1700 according to the embodiments described herein. For example, the external electronic device may be a portable computing device such as electronic tablet device, a personal computer, workstation, server, a desktop computer, a portable computer, a laptop, a mobile device, a personal digital assistant, a smartphone, a storage device, a portable media player, a navigation system, an interactive television, a video display terminal, a gaming console, a portable electronic device, another wearable electronic device, or any combination of these. Electronic device 1701 may include a display screen displaying a user interface for viewing by the user of the wearable electronic device 1700.

Wearable electronic device 1700 communicates with the external electronic device 1701 via a network 1702, which may be a Wi-Fi network, WiMAX, ZigBee, Z-Wave, Bluetooth™, Bluetooth™ Low Energy, near-field communication, or any other type of connection capable of providing uni-directional or bi-directional communication between the external electronic device 1701 and the wearable electronic device 1700.

The wearable electronic devices described herein may, in some implementations, employ any or all of the systems, devices, and/or methods described in U.S. Provisional Patent Application Ser. No. 62/608,463, U.S. Provisional Patent Application Ser. No. 62/607,819, and/or U.S. Provisional Patent Application Ser. No. 62/608,385.

Unless the specific context requires otherwise, throughout this specification and the appended claims the term “finger” is generally meant to be inclusive of the thumb.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including without limitation U.S. Provisional Patent Application Ser. No. 62/608,463, U.S. Provisional Patent Application Ser. No. 62/607,819, U.S. Provisional Patent Application Ser. No. 62/607,816, U.S. Provisional Patent Application Ser. No. 62/608,385, and U.S. Provisional Patent Application Ser. No. 62/642,490 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable electronic device wearable on a finger of a user, the wearable electronic device comprising:
a body defining an aperture therethrough, the aperture sized and shaped to receive the finger of the user; and
a control module removably coupleable to the body, the control module comprising:
a computer processor;
an input device to receive an input from another finger of the user; and
a transmitter communicatively coupled to the computer processor and operable to send electronic transmissions to an external electronic device, the electronic transmissions corresponding to the input received from the user.

2. The wearable electronic device of claim 1 wherein the control module further comprises: a power system electrically coupled to provide electrical power to the computer processor, the input device, and the transmitter.

3. The wearable electronic device of claim 1, wherein the control module further comprises a first mounting surface having at least one fastener aperture defined therein to receive a fastener, and wherein the first mounting surface rests against a first edge of the body when the control module is mounted to the body.

4. The wearable electronic device of claim 3, wherein the control module further comprises a second mounting surface having at least one fastener aperture defined therein to receive a fastener, and wherein the second mounting surface is removable and rests against a second edge of the body when the control module is mounted to the body.

5. (canceled)

6. The wearable electronic device of claim 1, wherein the body further comprises a planar mounting surface that extends from an outer surface of the body.

7. The wearable electronic device of claim 6, wherein the planar mounting surface defines at least one fastener aperture sized and shaped to receive a fastener for mounting the control module to the body.

8. (canceled)

9. (canceled)

10. The wearable electronic device of claim 6, wherein the control module further comprises at least one extension that is releaseably insertable into the at least one fastener aperture to releaseably mount the control module to the body.

11. The wearable control module of claim 1, wherein the body defines an opening extending between an inner surface of the body and an outer surface of the body, the opening shaped and sized to receive at least a portion of the control module to mount the control module to the body.

12. The wearable electronic device of claim 11, wherein the body comprises a side mounting surface and an end mounting surface that together define the opening, and wherein the control module rests against the side mounting surface and the end mounting surface when mounted to the body.

13. (canceled)

14. (canceled)

15. The wearable electronic device of claim 12, wherein the side mounting surface includes a recess via which the control module is mountable to the body, and wherein the control module includes an extension sized and shaped to slidingly engage the recess to mount the control module to the body.

16. The wearable electronic device of claim 11, wherein the body comprises two side mounting surfaces and two end mounting surfaces that collectively define the opening, wherein the control module rests against the side mounting surfaces and the end mounting surfaces when mounted to the body.

17. (canceled)

18. The wearable electronic device of claim 16, wherein each side mounting surface includes a respective recess via which the control module is mountable to the body, and wherein each recess extends between the inner surface of the body and the outer surface of the body.

19. The wearable electronic device of claim 18, wherein the control module includes two extensions, each extension sized and shaped to slidingly engage a respective one of the recesses to releaseably mount the control module to the body.

20. The wearable electronic device of claim 1, wherein the body comprises an upper projection and a lower projection spaced apart from each other to define an opening, the opening sized and shaped to receive the control module to releaseably mount the control module to the body.

21. The wearable electronic device of claim 20, wherein each of the upper and the lower projections has a planar shape and extends in a direction away from the finger of the user when the body is placed on the finger of the user.

22. The wearable electronic device of claim 21, wherein each of the upper and the lower projections comprises an extension via which the control module is releaseably mountable to the body.

23. The wearable electronic device of claim 22, wherein the control module comprises two recesses sized and shaped to slidingly receive one of the extensions of the body when the control module is positioned between the upper and the lower projections.

24. (canceled)

25. The wearable electronic device of claim 1, wherein the body comprises an upper projection, a lower projection spaced apart from the upper projection, and a post extending between the upper projection and the lower projection, the upper and the lower projections defining an opening, the opening sized and shaped to receive the control module to mount the control module to the body.

26. The wearable electronic device of claim 25, wherein each of the upper and the lower projections has a planar shape and extends in a direction away from the finger of the user when the body is placed on the finger of the user.

27. The wearable electronic device of claim 26, wherein the control module comprises a recess sized and shaped to slidingly receive the post when the control module is positioned between the upper and lower projections.

28. (canceled)
